(19) United States
(12) Patent Application Publication
(10) Pub. No.: US 2010/0267256 A1
(43) Pub. Date: Oct. 21, 2010

(54) Electric Connector

(75) Inventors: Manabu Eriguchi, Kanagawa (JP); Kazushige Asakawa, Kanagawa (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/992,377

(22) PCT Filed: Oct. 3, 2006
(86) PCT No.: PCT/US2006/038613

§ 371 Date: Jun. 8, 2010

(30) Foreign Application Priority Data
Oct. 3, 2005 (JP) 2005-289714D

(51) Int. Cl. H01R 12/16

(52) U.S. Cl. 439/83

(57) ABSTRACT

A board mount connector (10) includes a connector body configured to be mated with a counterpart connector (30) and a plurality of conductive terminals (20a, 20h) projecting from the connector body (11). Each of the terminals includes a contact portion (21a, 21b) configured to contact a corresponding terminal (33) of the counterpart connector (30), a leg portion (24a, 24b) configured to be inserted into a corresponding connection hole (41a, 41b) and soldered thereto, and a bent portion (23a, 23b) which connects the arm portion (21a, 21b) and the leg portion (24a, 24b). The bent portion (23a) of each longer terminal (20a) forms an arc with a center angle of 90 degrees and the bent portion (23b) of each shorter terminal (20b) forms an arc with a center angle greater than 90 degrees. The contact portion (21a, 21b) of the terminals extends parallel to the circuit board (41), and the leg portion (24a, 24b) of the terminals extends perpendicular to the circuit board (41).

### BACKGROUND OF THE INVENTION

1. Field of the Invention

The present invention relates to a board mount connector.

2. Description of the Related Art

Conventionally, there has been known a board mount connector which is mounted on a board, such as a printed circuit board, for connection with another electrical circuit or the like (see, for example, Japanese Patent Application Laid-Open (kokai) No. 2004-192871). Such a board mount connector includes a connector body, and a plurality of L-shaped terminals which project rearward from the connector body.

FIG. 5 is a perspective view showing a conventional board mount connector.

The board mount connector shown in FIG. 5 includes terminals 302 and 303, each formed of an electrically conductive material such as metal; and a box-shaped connector housing 304 formed of an insulating material such as synthetic resin and supporting the terminals 302 and 303. The board mount connector is a so-called plug connector, and a receptacle connector connected to an end of an unillustrated cable is inserted into the board mount connector.

Each of the terminals 302 and 303 is an L-shaped terminal, which projects rearward from the rear wall of the connector housing 304, and is bent at substantially a right angle, so that the distal end is directed downward. The downward-directed distal ends of the terminals 302 and 303 are inserted into through holes 306 and 307 formed in a circuit board 305, and are connected thereto by means of soldering. Thus, the terminals 302 and 303 are electrically connected to unillustrated conductive traces communicating with the through holes 306 and 307, and secure the connector housing 304 to the circuit board 305.

More specifically, the terminals 302 and 303 are bent so as to form acute bent portions 302a and 303a, respectively. This is because the terminals 302 and 303 collectively cancel spring back.

However, in the conventional board mount connector, the distance as measured from the downward-directed portions of the terminals 302 and 303 connected to the through holes 306 and 307 up to the opening of the connector housing 304 is long. Therefore, when the cable connected to the receptacle connector inserted into the board mount connector is pulled, the connector housing 304 may lift from the circuit board 305.

In recent years, there has arisen demand to reduce not only the size of a board mount connector itself but also the mounting area thereof. However, because of soldering accuracy and technical restrictions regarding the circuit board, the interval between the through holes 306 and 307 cannot be reduced to a predetermined distance or less. Therefore, the intervals between the downward-directed portions of the terminals 302 and 303 cannot be reduced, and thus, the distance as measured from the downward-directed portions of the terminals 303 up to the opening of the connector housing 304 increases, which makes it impossible to reduce the length (lateral dimension in FIG. 5) of the mounting area of the board mount connector and to reduce the mounting area.

### SUMMARY OF THE INVENTION

An object of the present invention is to solve the above-mentioned problems in the conventional board mount connector and to provide a board mount connector in which each shorter terminal is bent such that its bent portion forms an arc having a center angle greater than 90 degrees, and its board connection portion is located closer to the insertion opening of the housing. The board mount connector can reduce the required mounting area, and can prevent the housing from lifting from a board and terminals from coming off the board, which would otherwise occur when the board mount connector receives an external force.

In order to achieve the above object, the present invention provides a board mount connector comprising a connector body which is mated with a counterpart connector; and a plurality of terminals projecting from the connector body, the terminals being inserted into connection holes of a circuit board and soldered thereto, wherein the terminals are held by the connector body, and each of the terminals includes an arm portion which comes into contact with a corresponding terminal of the counterpart connector, a leg portion inserted into the corresponding connection hole, and a bent portion which connects the arm portion and the leg portion; the bent portion of each longer terminal forms an arc having a center angle of 90 degrees; the bent portion of each shorter terminal forms an arc having a center angle greater than 90 degrees; and the arm portion extends parallel to the circuit board, and the leg portion extends perpendicular to the circuit board.

Preferably, the arm portions of the shorter terminals are located closer to the circuit board than are the arm portions of the longer terminals; and the leg portions of the shorter terminals are located closer to a mating end face of the connector body than are the leg portions of the longer terminals.

Preferably, the leg portion of each shorter terminal is connected to the bent portion via a reverse bent portion bent in a direction opposite the bending direction of the bent portion.

Preferably, the connector body includes side wall portions and a canopy portion, which extend in a direction opposite the mating end face; the lower edge of an end portion of each of the side wall portions opposite the mating end face comes into contact with an upper surface of the circuit board at a position on a side of the leg portions of the longer terminals away from the mating end face of the connector body; and the canopy portion is parallel to the circuit board, and a tamper prevention plate member is placed on the canopy portion.

In the board mount connector of the present invention, each shorter terminal is bent such that its bent portion forms an arc having a center angle greater than 90 degrees, and its board connection portion is located closer to the insertion opening of the housing. Therefore, the board mount connector of the invention can reduce the required mounting area, and can prevent the housing from lifting from a board and terminals from coming off the board, which would otherwise occur when the board mount connector receives an external force.

### BRIEF DESCRIPTION OF THE DRAWINGS

FIG. 1 is a perspective view of a board mount connector according to an embodiment of the present invention;

FIG. 2 is a transversal sectional view of the board mount connector of the embodiment, showing a state after being mated with a counterpart connector;

FIG. 3 is a perspective view of the board mount connector of the embodiment, showing a state before being mated with the counterpart connector;

FIG. 4 is a perspective view of the board mount connector of the embodiment, showing a state after being mated with the counterpart connector; and

FIG. 5 is a view showing a conventional board mount connector.

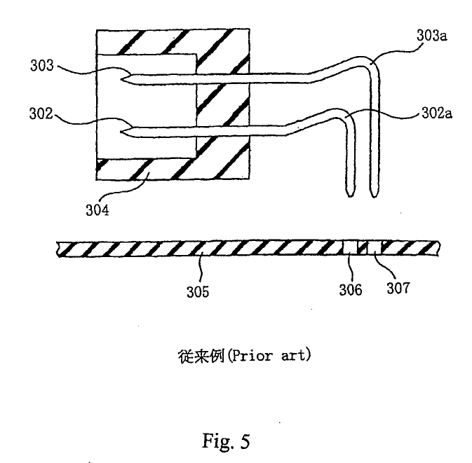

### DESCRIPTION OF THE PREFERRED EMBODIMENT

An embodiment of the present invention will next be described in detail with reference to the drawings.

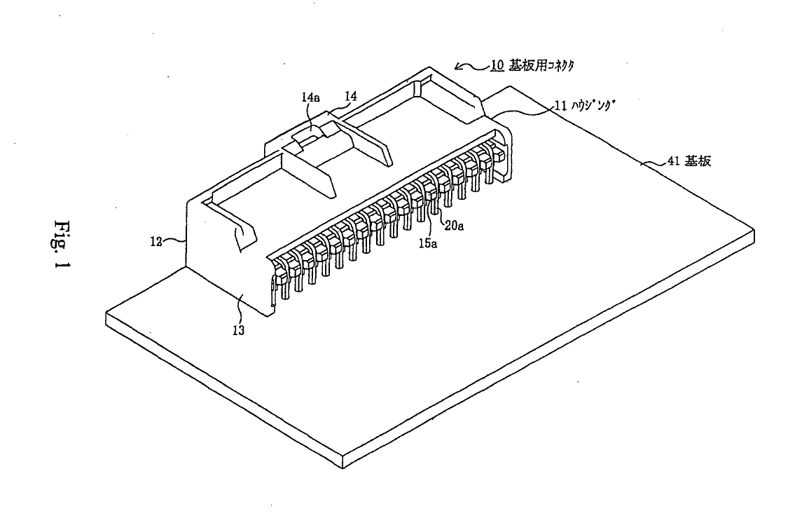

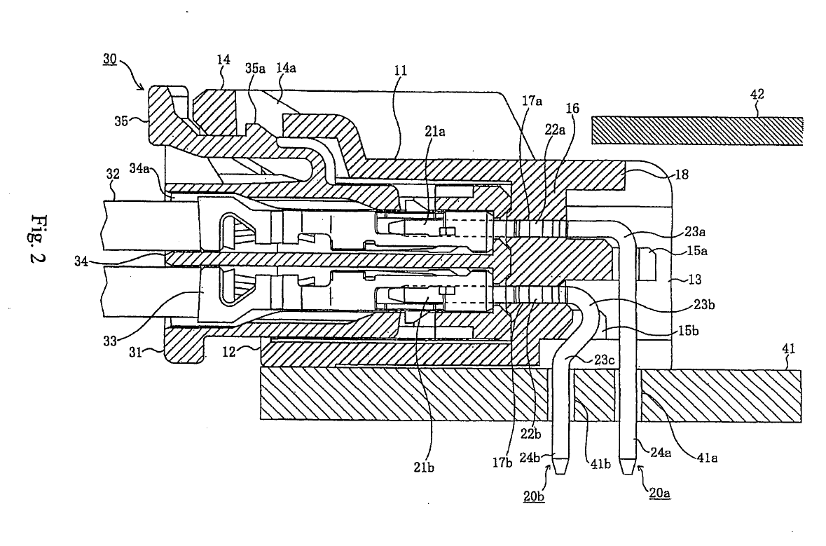

FIG. 1 is a perspective view of a board mount connector according to an embodiment of the present invention; and FIG. 2 is a transversal sectional view of the board mount connector of the embodiment, showing a state after being mated with a counterpart connector.

In FIG. 1, reference numeral 10 denotes a board mount connector according to the present embodiment, which is mounted on a board (circuit board) 41 and mated with a counterpart connector 30 so as to establish electrical connection between the board 41 and an apparatus connected to the counterpart connector 30. In the present embodiment, the counterpart connector 30 may be used not only for connection of a cable which includes wires 32 each having a circular cross section, as shown in FIG. 2, but also for connection of a plate-shaped flexible cable such as a flexible flat cable (FFC) or flexible printed circuit (FPC). In the present embodiment, terms for expressing direction, such as up, down, left, right, front, and rear, are used for explaining the structure and action of respective portions of the board mount connector 10 and the counterpart connector 30; however, these terms represent respective directions for the case where the board mount connector 10 and the counterpart connector 30 are used in an orientation shown in the drawings, and must be construed to represent corresponding different directions when the orientation of the board mount connector 10 and the counterpart connector 30 is changed.

The board mount connector 10 is a plug connector, and includes a housing (connector body) 11 and first and second terminals 20a and 20b. The housing 11 is integrally formed from an insulative material such as a synthetic resin, and is mated with the counterpart connector 30. The first and second terminals 20a and 20b are formed of metal and attached to the housing 11 such that the terminals 20a and 20b pass through a terminal press-fitting portion 16 of the housing 11.

The housing 11 has a generally parallelepiped shape, and has an opening which is formed in an end face for receiving the counterpart connector 30 (hereinafter the end face is called “mating end face). The opening serves as a mating opening 12 for mating with the counterpart connector 30. An engagement bulge portion 14, which serves as a lock member, is integrally formed on the top surface of the housing 11 in the vicinity of a side edge adjacent to the mating opening 12. The engagement bulge portion 14 comes into engagement with an engagement arm 35 of the counterpart connector 30 and locks the counterpart connector 30, which is integrated with an end portion of a cable. Moreover, an engagement opening 14a for engagement with an engagement projection 35a of the engagement arm 35 is formed in the engagement bulge portion 14.

The first terminals 20a are longer terminals, and their total number is 17. The first terminals 20a are arranged in an upper row in the housing 11 at a pitch of 2.0 mm. The second terminals 20b are shorter terminals, and their total number is 17. The second terminals 20b are arranged in a lower row in the housing 11 at a pitch of 2.0 mm. Notably, the numbers and pitches of the first and second terminals 20a and 20b can be changed freely.

In the present embodiment, each of the first terminals 20a includes a first arm or contact portion 21a which extends parallel to the board 41 and whose distal end portion comes into contact with a corresponding wire terminal 33 of the counterpart connector 30; a first penetration portion 22a which is a portion of the first arm portion 21a and fitted into the terminal press-fitting portion 16 of the housing 11; a first bent portion 23a connected to a rear end of the first arm portion 21a; and a first leg portion 24a which extends perpendicular to the board 41 and whose lower end portion passes through the board 41. Each of the second terminals 20b includes a second arm or contact portion 21b which extends parallel to the board 41 and whose distal end portion comes into contact with a corresponding wire terminal 33 of the counterpart connector 30; a second penetration portion 22b which is a portion of the second arm portion 21b and fitted into the terminal press-fitting portion 16 of the housing 11; a second bent portion 23b connected to a rear end of the second arm portion 21b; and a second leg portion 24b which extends perpendicular to the board 41 and which passes through the board 41. Notably, when the first terminals 20a and the second terminals 20b are collectively described, they will be referred to as the “terminals 20.” Further, when the respective arm portions, penetration portions, bent portions, and leg portions of the first and second terminals 20a and 20b are collectively described, they will be referred to as the “arm portions 21,” the “penetration portions 22,” the “bent portions 23,” and the “leg portions 24,” respectively.

The board mount connector 10 is a so-called right-angle-type connector. As shown in FIGS. 1 and 2, the board mount connector 10 is mounted onto the board 41 through soldering the leg portions 24 of the terminals 20 to the board 41, in a state in which the board mount connector 10 is parallel to the board 41; i.e., in a state in which the mating opening 12 faces horizontally and the terminal press-fitting portion 16 is perpendicular to the board 41. In the illustrated example, the board mount connector 10 is mounted such that the mating opening 12 extends along a side edge of the board 41. The first and second arm portions 21a and 21b extend parallel to the board 41, and their distal ends (ends located on the side toward the mating opening 12) come into engagement and contact with the wire terminals 33. Notably, the overall length of the first terminals 20a is greater than the overall length of the second terminals 20b. More specifically, the lengths of the first arm portion 21a and first leg portion 24a of each first terminal 20a are longer than the lengths of the second arm portion 21b and second leg portion 24b of each second terminal 20b. Notably, the first and second terminals 20a and 20b are identical in thickness (transverse cross section).

The first and second terminals 20a and 20b are held by the housing 11 in such a manner that the first arm portion 21a of each first terminal 20a is located higher than the second arm portion 21b of a corresponding second terminal 20b; i.e., on the side away from the board 41 with respect to the second arm portion 21b, and the first leg portion 24a of each first terminal 20a is located on the rear side (right-hand side in FIG. 2) of the second leg portion 24b of a corresponding second terminal 20b; i.e., on the side away from the mating end face with respect to the second leg portion 24b. Notably, the distal ends of the first and second arm portions 21a and 21b are generally located in a common vertical plane; and the lower ends of the first and second leg portions 24a and 24b are generally located in a common horizontal plane.

Further, as shown in FIG. 2, first and second terminal insertion holes 17a and 17b are formed in the terminal press-fitting portion 16 of the housing 11 such that the holes horizontally penetrate the terminal press-fitting portion 16. The first penetration portions 22a of the first terminals 20a are fitted into the first terminal insertion holes 17a, and the second penetration portions 22b of the second terminals 20b are fitted into the second terminal insertion holes 17b. Thus, the first and second terminals 20a and 20b are secured to the terminal press-fitting portion 16. Notably, in order to reliably hold the first and second terminals 20a and 20b, projections which bite into the inner wall surfaces of the first and second terminal insertion holes or receiving cavities 17a and 17b are desirably formed on the surfaces of the first and second penetration or retention portions 22a and 22b. Further, the first and second penetration portions 22a and 22b and the first and second terminal insertion holes 17a and 17b preferably have sufficient lengths such that the first and second terminals 20a and 20b are held with at least a predetermined holding force. Moreover, in order to render the holding force for the first terminals 20a equal to that for the second terminals 20b, the lengths of the first penetration portions 22a and the first terminal insertion holes 17a are desirably made equal to those of the second penetration portions 22b and the second terminal insertion holes 17b. Notably, when the first and second terminal insertion holes 17a and 17b are collectively described, they will be referred to as the “terminal insertion holes 17.”

A rear end portion of the first arm portion 21a of each first terminal 20a, which end portion is located rearward of the first penetration portion 22a, projects rearward from the terminal press-fitting portion 16, extends parallel to the board 41, and connects with the first bent portion 23a. The first bent portion 23a is a portion for connecting the first arm portion 21a and the first leg portion 24a together, and forms an arc having a center angle of 90 degrees. Therefore, the first arm portion 21a and the first leg portion 24a are connected via the first bent portion 23a such that their axes perpendicularly intersect each other. Therefore, the first leg portion 24a extends vertically; i.e., perpendicular to the board 41 at a position which is slightly separated rearward from the rear end of the first arm portion 21a. The lower end portion of the first leg portion 24a is inserted into (passes through) a corresponding one of first through holes (connection holes) 41a formed in the board 41. Notably, the first through holes 41a are arranged so as to correspond to the arrangement of the first leg portions 24a, and are electrically connected to unillustrated conductive traces. The lower end portions of the first leg portions 24a received in the first through holes 41a are soldered thereto, and function as a board connection portion for establishing electrical connection with the conductive traces formed on the board 41. Further, as a result of the lower end portions of the first leg portions 24a being soldered to the first through holes 41a, the board mount connector 10 is secured to the board 41.

The second arm portion 21b of each second terminal 20b does not have an end portion located rearward of the second penetration portion 22b. The rear end of the second penetration portion 22b, which corresponds to the rear end of the second arm portion 21b, connects with the second bent portion 23b. The second bent portion 23b is a portion for connecting the second arm portion 21b and the second leg portion 24b together, and forms an arc having a center angle greater than 90 degrees. Therefore, if the second leg portion 24b is connected directly to the lower end of the second bent portion 23b, the axis of the second leg portion 24b does not perpendicularly intersect that of the second arm portion 21b. In view of this, a reverse bent portion 23c, which bends in the direction opposite the bending direction of the second bent portion 23b, is connected to the lower end of the second bent portion 23b, and the second leg portion 24b is connected to the reverse bent portion 23c. Thus, the second arm portion 21b and the second leg portion 24b are connected via the second bent portion 23b and the reverse bent portion 23c such that their axes perpendicularly intersect each other, and the second leg portion 24b extends perpendicular to the board 41. Notably, the second leg portion 24b is located forward of the first leg portion 24a; i.e., on the side toward the mating opening 12 with respect to the first leg portion 24a.

As shown in FIG. 2, the portion composed of the second bent portion 23b and the reverse bent portion 23c has a side shape resembling an inverted letter S or a question mark “?.” By means of connecting the second arm portion 21b and the second leg portion 24b via the second bent portion 23b and the reverse bent portion 23c, the second leg portion 24b can be disposed further forward; i.e., at a position closer to the mating opening 12, as compared with the case where they are connected via a bent portion which forms a 90-degree arc, such as the first bent portion 23a.

The second leg portion 24b is inserted into (passes through) a corresponding one of second through holes (connection holes) 41b formed in the board 41. Notably, since the second leg portion 24b is shorter than the first leg portion 24a, in contrast with the first leg portion 24b whose lower end portion is inserted into the first through hole 41a, a portion of the second leg portion 24b extending from a point immediately below the upper end thereof is inserted into the second through hole 41b. The second through holes 41b are arranged so as to correspond to the arrangement of the second leg portions 24b, and are electrically connected to unillustrated conductive traces. The second leg portions 24b received in the second through holes 41b are soldered thereto, and function as a board connection portion for establishing electrical connection with the conductive traces formed on the board 41. Further, as a result of the second leg portions 24b being soldered to the second through holes 41b, the board mount connector 10 is secured to the board 41.

The housing 11 includes first and second alignment-support portions 15a and 15b integrally formed to project rearward from the rear face of the terminal press-fitting portion 16. The rear end (right-hand end in FIG. 2) of the first alignment-support portion 15a is formed into the shape of a comb having teeth. The upper end portions of the first leg portions 24a are inserted between corresponding teeth, whereby the first arm portions 21a are aligned. The rear end (right-hand end in FIG. 2) of the second alignment-support portion 15b is formed into the shape of a comb having teeth. The second bent portions 23b are inserted between corresponding teeth, whereby the second arm portions 21b are aligned. Notably, when the first and second alignment-support portions 15a and 15b are collectively described, they will be referred to as the “alignment-support portions 15.”

Moreover, at the opposite ends with respect to the longitudinal direction (direction perpendicular to the sheet of FIG. 2), side wall portions 13 are formed integrally with the housing 11 such that the side wall portions 13 extend rearward from the terminal press-fitting portion 16 toward the direction opposite the mating end face. The outer side surfaces of the side wall portions 13 are approximately flush with the side surfaces of the housing 11 at the opposite longitudinal ends thereof. The lower surfaces of the side wall portions 13 are parallel to the upper surface of the board 41 and are in engagement therewith. Since the side wall portions 13 project further rearward than the first arm portion 21a and the first alignment-support portion 15a, the rear ends of the side wall portions 13 located opposite the mating end face come into engagement with the upper surface of the board 41 at a position which is separated further from the mating end face of the housing 11 than are the first leg portion 24a and the first through hole 41a.

Further, the housing 11 has a canopy portion 18, which is formed integrally with the housing 11 so as to extend rearward from the upper end of the terminal press-fitting portion 16. The upper surface of the canopy portion 18 is approximately flush with the upper surface of the housing 11. The upper surface of the canopy portion 18 is parallel to the upper surface of the board 41, and a tamper prevention cover (tamper prevention plate member) 42 is placed on the canopy portion 18. The tamper prevention cover 42 mainly prevents an undesired or illegal act of bringing a probe into contact with the terminals 20 exposed between the terminal press-fitting portion 16 of the housing 11 and the board 41.

In recent years, in order to tamper with a game machine, there has been performed an illegal act of bringing a probe into contact with the terminals of a connecter connected to a circuit board of the game machine, to thereby supply a tampering signal to a signal circuit of the game machine. In this case, a probe is often inserted between the circuit board and the connector mounted on the circuit board so as to bring the probe into contact with the terminals projecting from the connecter. In order to prevent such an illegal act, there has been proposed attachment of a sheet-shaped or plate-shaped tamper prevention cover formed of resin to be located above the circuit board carrying the connector. The tamper prevention cover, which covers the circuit board from above, can prevent insertion of a probe through a space between the connector and the surface of the circuit board.

The board mount connector 10 of the present embodiment may be used in a game machine as well. Therefore, the canopy portion 18 is formed on the housing 11 of the board mount connector 10, and the canopy portion 18 is parallel to the board 41 and is adapted to receive the tamper prevention cover 42. By virtue of this configuration, the terminals 20, which are exposed in a region extending form the rear face of the terminal press-fitting portion 16 to the board 41, are covered from above with the canopy portion 18 and the tamper prevention cover 42, whereby illegal tampering can be prevented without fail. For clarity, the tamper prevention cover 42 is not illustrated in the drawings other than FIG. 2.

The counterpart connector 30 is a receptacle connector, and includes a housing (connector body) 31 which is integrally formed from an insulative material such as a synthetic resin. The housing 31 assumes a generally parallelepiped shape, and has a plurality of terminal accommodation holes 34a defined by partition walls 34 combined to form a grid-like cross section. The terminal accommodation holes 34a are through holes each having a rectangular cross section, and extend from the left-hand end to the right-hand end of the housing 31 in FIG. 2. The terminal accommodation holes 34a accommodate the wire terminals 33 connected to end portions of the wires 32. The wire terminals 33 are desirably accommodated within the terminal accommodation holes 34a in an engaged state, whereby removal of the wire terminals 33 is prevented. The wire terminals 33 are arranged in the same manner as the terminals 20 of the board mount connector 10, and are connected to the corresponding terminals 20. Notably, the wire terminals 33 are not necessarily required to be inserted into all the terminal accommodation holes 34a, and some of the wire terminals 33 may be omitted such that the arrangement of the wire terminals 33 matches the arrangement of the terminals 20 of the board mount connector 10.

The above-mentioned engagement arm portion 35, which serves as a lock member, is integrally formed with the housing 31 to be located in the vicinity of the upper edge of one side surface of the housing 31. The engagement arm portion 35 comes into engagement with the engagement bulge portion 14 of the board mount connector 10, and enters a locked state. The engagement arm portion 35 is cantilevered such that its one end serves as a free end, and the engagement projection 35a is integrally formed with the engagement arm portion 35 for engagement with the engagement opening 14a of the engagement bulge portion 14.

As shown in FIG. 2, in a state in which the board mount connector 10 and the counterpart connector 30 are mated with each other, the housing 31 of the counterpart connector 30 is mostly inserted and accommodated in the housing 11 of the board mount connector 10, and the engagement arm portion 35 is accommodated in the engagement bulge portion 14 such that the engagement projection 35a is engaged with the engagement opening 14a, and is locked. That is, inner-lock-type mating is achieved in which the lock member of the counterpart connector 30 is inserted into the interior of the lock member of the board mount connector 10, and is locked. Therefore, when an operator manipulates the counterpart connector 30 with his or her fingers and/or thumb, the operator can feel a click upon engagement of the engagement projection 35a with the engagement opening 14a. Moreover, since a state in which the engagement projection 35a is located within the engagement opening 14a can be visually confirmed, the operator can readily check whether the counterpart connector 30 has been inserted into the board mount connector 10 and locked without fail.

Next, operation of mating the counterpart connector 30 with the board mount connector 10 will be described.

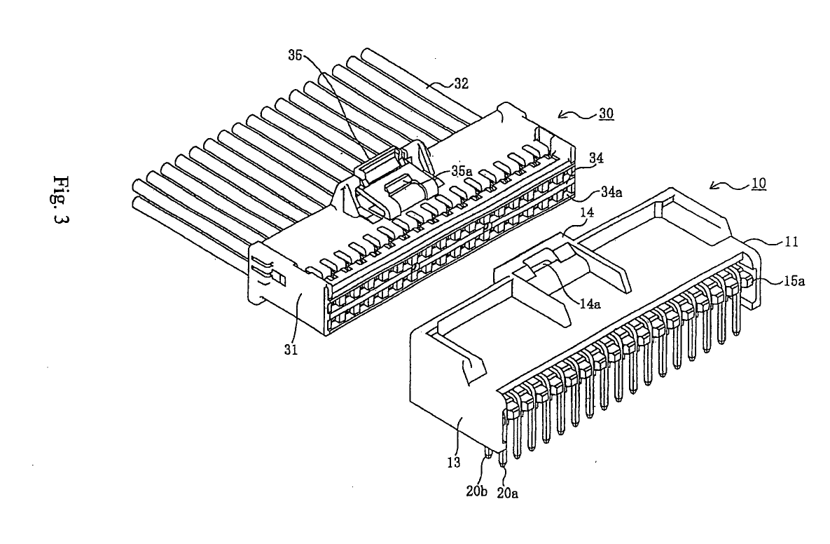

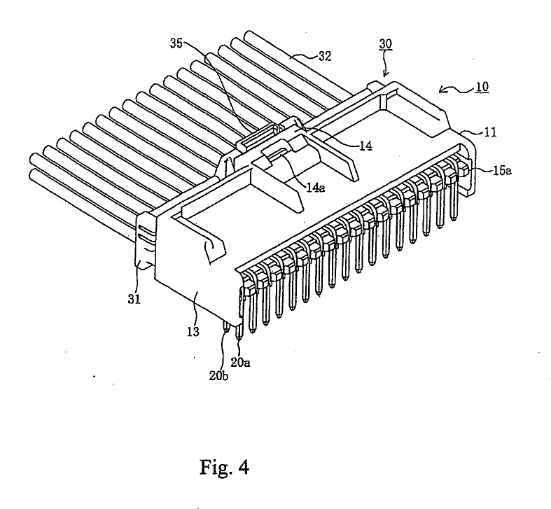

FIG. 3 is a perspective view of the board mount connector of the embodiment, showing a state before being mated with the counterpart connector; and FIG. 4 is a perspective view of the board mount connector of the embodiment, showing a state after being mated with the counterpart connector.

When the counterpart connector 30 is to be inserted into or mated with the board mount connector 10 mounted onto the board 41, an operator manipulates the counterpart connector 30 with, for example, his or her fingers and positions the counterpart connector 30 in front of the mating end face of the board mount connector 10 such that the mating end face of the counterpart connector 30 horizontally faces toward the mating end face of the board mount connector 10. Notably, the board 41 is not illustrated in FIGS. 3 and 4. The orientation of the counterpart connector 30 is adjusted such that the side surface on which the engagement arm portion 35 is formed faces the same direction as the side face of the board mount connector 10 on which the engagement bulge portion 14 is formed. Subsequently, the operator moves the counterpart connector 30 horizontally so as to insert the counterpart connector 30 into the housing 11 of the board mount connector 10, so that, as shown in FIG. 4, the counterpart connector 30 is mated with the board mount connector 10.

At that time, the engagement arm portion 35 of the counterpart connector 30 is inserted into the engagement bulge portion 14 of the board mount connector 10. Thus, the operator can feel a sufficient click upon engagement of the engagement projection 35a with the engagement opening 14a. Moreover, since the operator can visually check from the outside the state in which the engagement projection 35a is located within the engagement opening 14a, the operator can readily check whether the counterpart connector 30 has been inserted into the board mount connector 10 and locked without fail.

As described above, in the present embodiment, the first and second terminals 20a and 20b are held by the housing 11; each of the first terminals 20a includes the first arm portion 21a which comes into contact with a corresponding wire terminal 33 of the counterpart connector 30, the first leg portion 24a to be inserted into the first through hole 41a of the board 41, and the first bent portion 23a which connects the first arm portion 21a and the first leg portion 24a; and each of the second terminals 20b includes the second arm portion 21b which comes into contact with a corresponding wire terminal 33 of the counterpart connector 30, the second leg portion 24b to be inserted into the second through hole 41a of the board 41, and the second bent portion 23b which connects the second arm portion 21b and the second leg portion 24b. The first bent portion 23a forms an arc having a center angle of 90 degrees; and the second bent portion 23b forms an arc having a center angle greater than 90 degrees.

By virtue of this configuration, as compared with the case where the second leg portion 24b is connected to the second arm portion 21b via a bent portion which forms a 90-degree arc as in the case of the first bent portion 23a, the second leg portion 24b can be disposed further forward; i.e., at a position closer to the mating opening 12. Therefore, even when the length of a mounting area for the board mount connector 10 with respect to the front-rear direction is shortened so as to reduce the mounting area, the distance between the first leg portion 24a and the second leg portion 24b can be increased so as to dispose the second leg portion 24b at a position closer to the mating opening 12. Accordingly, even in the case where the mating end of the housing 11 receives an upward external force; e.g., when the cable of the counterpart connector 30 mated with the board mount connector 10 is pulled, the second terminals 20b are not bent and the mating end of the housing 11 does not lift, because the second leg portion 24b is fixed to the board 41 at a position close to the mating end of the housing 11.

Since the second leg portion 24b is disposed at a position closer to the mating opening 12 as compared with the second bent portion 23b, the lengths of the second penetration portion 22b and the second terminal insertion hole 17b are not required to be shortened, so that the holding force with which each second terminal 20b is held does not decrease. Therefore, the strength of the second terminal 20b against insertion and removal of a counterpart terminal can be maintained. Moreover, the distance between the first leg portion 24a and the second leg portion 24b can be increased even when the board mount connector 10 is downsized. Therefore, the board mount connector 10 can be mounted on a board 41 in which the distance between the first through hole 41a and the second through hole 41b cannot be reduced because of technical restrictions such as restriction on soldering.

The housing 11 includes the side wall portions 13, which extend in a direction opposite the mating end face; the lower edges of end portions thereof located opposite the mating end face come into contact with the upper surface of the circuit board 41 on a side of the first leg portions 24a of the first terminals 20a away from the mating end face of the housing 11. Therefore, even in the case where the mating end of the housing 11 receives an upward external force, soldered portions do not receive a large stress, because of the long distance between the lower edges of the end portions of the side wall portions 13 opposite to the mating end face and the soldered portions between the first and second leg portions 24a and 24b and the first and second through holes 41a and 41b. Thus, generation of solder cracks can be prevented.

The housing 11 further includes the canopy portion 18, which extends in a direction opposite the mating end face, and the tamper prevention cover 42 is placed on the canopy portion 18. Therefore, it is possible to reliably prevent an illegal act of bringing a probe into contact with the terminals 20 exposed between the terminal press-fitting portion 16 of the housing 11 and the board 41.

Notably, in the present embodiment, the terminals 20 include terminals of two types; i.e., the first and second terminals 20a and 20b. However, the terminals 20 may include terminals of three or more types.

The present invention is not limited to the above-described embodiments. Numerous modifications and variations of the present invention are possible in light of the spirit of the present invention, and they are not excluded from the scope of the present invention.

What is claimed is:

1. A board mount connector (10) comprising:
(a) an insulative connector body (11) configured to be mated with a counterpart connector (30); and
(b) a plurality of conductive terminals (20a, 20b) secured within and projecting from the connector body (11), the terminals (20a, 20b) being configured to be inserted into connection holes (41a, 41b) of a circuit board (41) and soldered thereto, and wherein
(c) each of the terminals includes a contact portion (21a, 21b) configured to contact with a corresponding terminal (33) of the counterpart connector (30), a leg portion (24a, 24b) configured to be inserted into the corresponding connection hole (41a, 41b), and a bent portion (23a, 23b) which connects the contact portion (21a, 21b) and the leg portion (24a, 24b);
(d) the bent portion (23a) of each longer terminal (20a) forms an arc having a center angle of 90 degrees;
(e) the bent portion (23b) of each shorter terminal (20b) forms an arc having a center angle greater than 90 degrees; and
(f) the contact portion (21a, 21b) extends parallel to the circuit board (41), and the leg portion (24a, 24b) extends perpendicular to the circuit board (41).

2. The board mount connector (10) according to claim 1, wherein
(a) the contact portions (21b) of the shorter terminals (20b) are located closer to the circuit board (41) than are the contact portions (21a) of the longer terminals (20a); and
(b) the leg portions (24b) of the shorter terminals (20b) are located closer to a mating end face of the connector body (11) than are the leg portions (24a) of the longer terminals (20a).

3. The board mount connector (10) according to claim 1, wherein the leg portion (24b) of each shorter terminal (20b) is connected to the bent portion (23b) via a reverse bent portion (23c) bent in a direction opposite the bending direction of the bent portion (23b).

4. The board mount connector (10) according to claim 2, wherein the connector body (11) includes side wall portions (13) and a canopy portion (18); the lower edge of an end portion of each of the side wall portions (13) opposite the mating end face comes into contact with an upper surface of the circuit board (41) at a position on a side of the leg portions (24a) of the longer terminals (20a) away from the mating end face of the connector body (11); and the canopy portion (18) is parallel to the circuit board (41), and a tamper prevention plate member (42) is placed on the canopy portion (18).
